(19) United States
(12) Patent Application Publication
(10) Pub. No.: US 2026/0167024 A1
(43) Pub. Date: Jun. 18, 2026

(54) TRACTION INVERTER INTEGRATED WITH DC CHARGER

(71) Applicant: FORD GLOBAL TECHNOLOGIES, LLC, Dearborn, MI (US)

(72) Inventors: Baoming Ge, Okemos, MI (US); Fan Xu, Novi, MI (US)

(21) Appl. No.: 18/980,762

(22) Filed: Dec. 13, 2024

(51) Int. Cl. B60L 53/10; B60L 53/22

(52) U.S. Cl. CPC B60L 53/11; B60L 53/22; B60L 2210/42

(57) ABSTRACT

A vehicle power system includes a traction battery, motor, and inverter arrangement. The inverter includes phase legs with switches and capacitors in series, supplemented by a first set of inductors that can be selectively connected in parallel. A switch bank enables connection to a charging station for energy transfer. The system also has a second set of inductors, each with a terminal connected between a switch and its corresponding capacitor.

### TECHNICAL FIELD

This disclosure relates to vehicle power systems.

### BACKGROUND

Electric vehicle batteries often come in standard voltages with higher voltages offering faster charging capabilities. DC fast chargers provide high-power charging directly to the electric vehicle battery.

### SUMMARY

A vehicle includes a traction battery, a motor, and an inverter arrangement electrically connected between the battery and motor. The inverter arrangement comprises multiple phase legs, each having a pair of switches and a capacitor connected in series. A switch bank enables the selective electrical connection of the system to a charging station. The system also incorporates a first set of inductors that can be selectively connected in parallel with the switches and capacitors.

the system may include a second set of inductors, each having a terminal connected between one of the switches and the associated capacitor within the phase legs. This dual inductor setup allows for modulation of current and voltage. Such an arrangement reduces electromagnetic interference. The selective connection of inductors and capacitors within the phase legs facilitates system operation.

### BRIEF DESCRIPTION OF THE DRAWINGS

FIGS. 1, 2, and 3 are schematic diagrams of inverters in various contexts.

FIG. 4 is a schematic diagram of an electric drive system.

FIGS. 5A, 5B, 6A, and 6B are simulated voltage and current waveforms versus time.

### DETAILED DESCRIPTION

Detailed embodiments are provided here for illustrative purposes. These embodiments, however, are merely examples, and the design can take various forms. The figures are not necessarily drawn to scale, and certain features may be exaggerated or minimized to emphasize specific component details. Consequently, the structural and functional specifics disclosed here should not be considered limiting, but rather as a guide for those skilled in the art to apply the design in different ways.

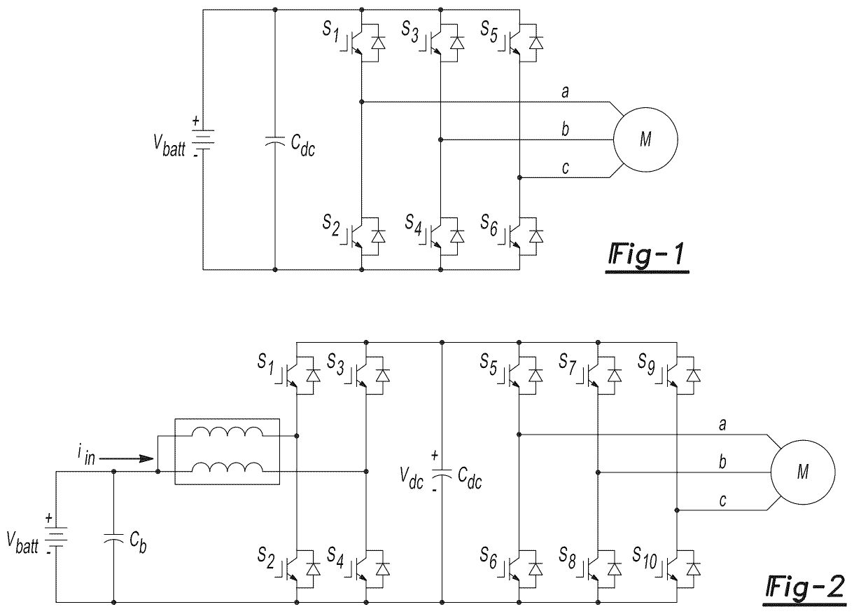

FIG. 1 shows a three-phase inverter circuit used to drive an electric motor in automotive applications. The system starts with the DC voltage source Vbatt, which is the vehicle's battery. This battery supplies the necessary DC power for the inverter, which then converts it into three-phase AC power to drive the motor. Connected across the DC bus, the capacitor Cdc often called the DC-link or filter capacitor, stabilizes the DC voltage, helping to filter out high-frequency ripples from the battery.

The circuit contains six semiconductor switches S1 through S6, usually implemented as insulated gate bipolar transistors (IGBTs) or metal-oxide-semiconductor field-effect transistors (MOSFETs). These switches are arranged in a three-phase bridge configuration to create the AC output needed for the motor. The output terminals a, b, c connect to the three phases of the electric motor, allowing the inverter to output a three-phase AC voltage that controls the motor's speed and torque. The motor, represented by the symbol M, is typically a three-phase AC motor used to drive the wheels.

A purpose of this inverter circuit is to convert DC power from the battery into a controlled three-phase AC output for the motor. This conversion is achieved by switching the transistors in a coordinated sequence to create an AC waveform at each output terminal. The switches work in pairs, where, for example, S1 and S2 are operated in an on-off pattern while controlling the voltage applied to each motor phase. To approximate a sinusoidal AC waveform, the switches are typically controlled using pulse-width modulation (PWM), where they are turned on and off at high frequencies. By varying the duty cycle of the PWM signals, the inverter can adjust the amplitude and frequency of the AC voltage applied to the motor.

The inverter generates three separate phase outputs that are each shifted 120° from one another. This three-phase AC voltage is applied to the motor's stator windings, creating a rotating magnetic field that drives the motor. The inverter controls the motor's speed by adjusting the frequency of the AC output and can control the torque by adjusting the amplitude.

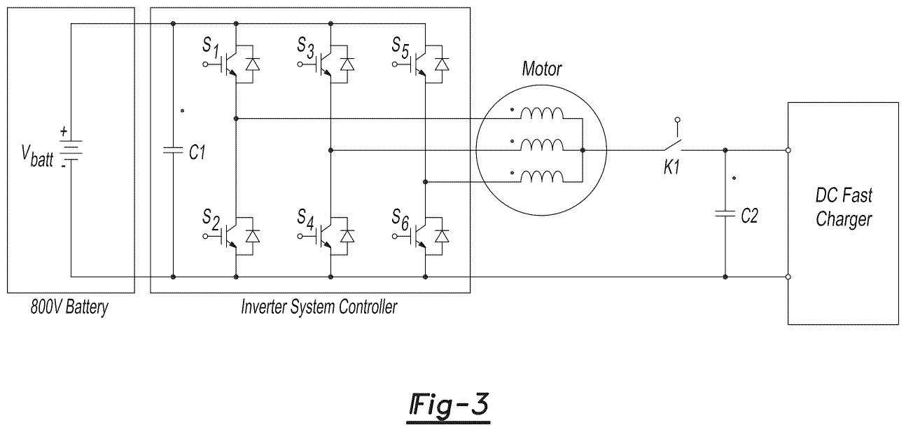

FIG. 2 shows a dual-stage inverter system, typically found in electric vehicles where DC from the battery is converted to AC to drive a motor. The system is powered by a battery source Vbatt, which provides the primary DC voltage. Connected to the battery is an input capacitor Cb, which smooths out fluctuations in the battery's output and filters high-frequency noise. The inductor L follows, working to limit current ripple in the circuit, particularly for the boost converter stage that is formed by switches S1, S2, S3, S4.

In this boost converter stage, the switches are configured in an H-bridge arrangement and operate alongside the inductor to increase the input voltage from Vbatt to a higher level, represented as Vdc. When a pair of switches (like S1 and S3) is closed, current flows from the battery through the inductor, storing energy within its magnetic field. Once these switches open, the inductor releases this stored energy, effectively boosting the voltage, which is then captured by the DC-link capacitor Cdc. This capacitor smooths out any ripples.

The second stage of the circuit is a three-phase inverter, composed of six switches, S5 through S10, arranged to convert the boosted DC voltage Vdc into a three-phase AC output. Each switch pair controls one of the three output phases. By modulating the timing and duty cycle of each switch, the inverter produces a sinusoidal AC waveform across these three phases, which are then fed to the motor M. This motor, often an AC induction or permanent magnet synchronous motor, converts the electrical power into mechanical motion, allowing it to drive the vehicle.

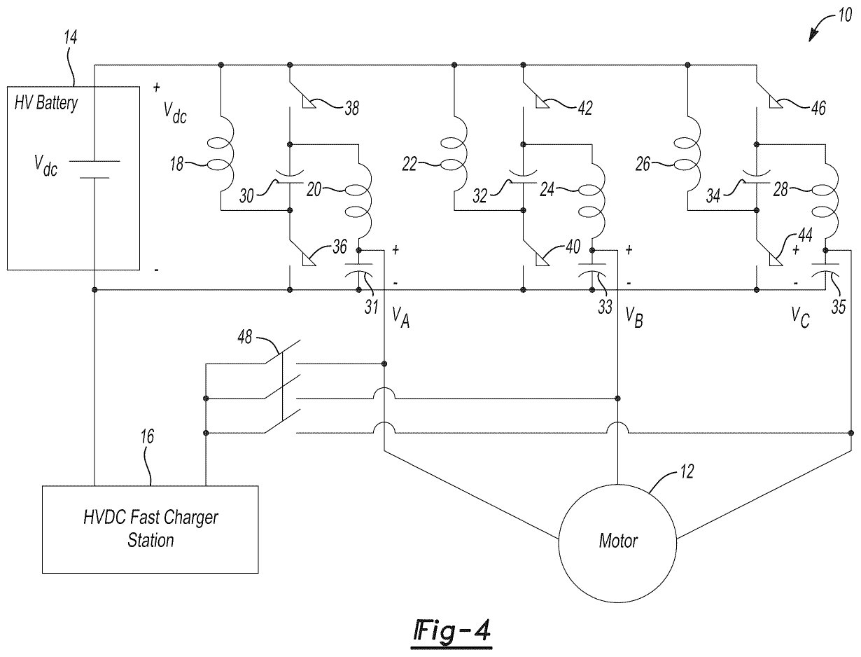

FIG. 3 shows a system for an 800V battery connected to an inverter system controller (ISC), motor, and DC fast charger. The primary components include the 800V battery, inverter switches (S1 to S6), capacitors (C1 and C2), a motor, and a DC fast charger with a contactor switch (K1).

In this setup, the 800V battery provides the main power source for the vehicle's motor. The ISC manages the conversion of DC power from the battery to AC power for driving the motor. The six switches (S1 to S6) form a three-phase bridge inverter that controls the power flow to the motor's windings. Capacitor C1, positioned within the ISC, stabilizes the DC voltage. The motor connects to the inverter, where the switching pattern of S1 through S6 determines the current direction and magnitude in each phase, to generate the required torque to drive the vehicle.

The system is designed to support DC fast charging, allowing the battery to be recharged quickly using high-voltage (HV) direct current. When connected to a DC fast charger, the system can handle either 400V or 800V input. If the DC fast charger operates at 400V, the inverter and motor windings function in a voltage boost mode to elevate the voltage, charging the 800V traction battery. In this mode, the inverter switches dynamically control the power flow, enabling the system to draw 400V and step it up to 800V. However, this approach may introduce inefficiencies due to power losses within the motor windings and core, resulting in reduced charging efficiency. Additionally, torque may be generated when current flows through the motor windings.

In contrast, if an 800V DC fast charger is used, the system bypasses the inverter for direct charging by turning on switches the S1, S3, S5. This configuration creates a direct path for the 800V DC current to flow to the battery without significant intervention from the inverter. While this setup does not require voltage boosting and thereby reduces losses, the lack of isolation for the motor windings in this bypass mode can still lead to minor torque due to residual currents, especially if the motor windings require a neutral.

This design may not be suitable for all vehicles, which may require the motor windings' neutral point to be connected to the charger interface circuit. It is also inherently limited to vehicles with an 800V battery, as it lacks the ability to buck (step down) voltage, meaning it cannot charge a 400V battery from an 800V charger.

This disclosure proposes a traction inverter integrated with a HVDC fast charger. Features may include a sinusoidal AC phase voltage output instead of a PWM pulse voltage output, compatibility with both 400V and 800V traction batteries, and the ability to charge either battery type using both 400V and 800V DC fast charging stations. Additionally, the system may support single-stage voltage inversion, as well as bidirectional buck and boost capabilities.

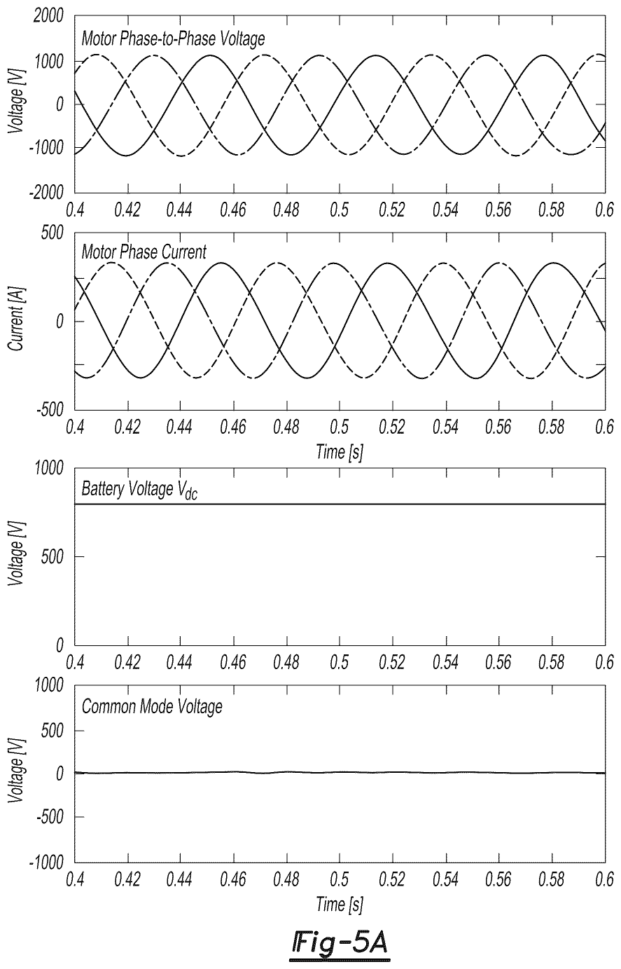

FIG. 4 shows the inverter system 10 that enables dual functionality: it can drive an electric motor 12 and charge a HV battery 14 via an HVDC fast charger 16. The system 10 is organized into three main phase legs—A, B, and C—each including inductors, capacitors, and switching devices connected between positive and negative rails and that work together to produce and control the required voltage waveforms for motor operation and charging.

Starting with the HV battery 14, this provides the main DC input voltage to the inverter system 10. The battery 14 connects to the three-phase inverter circuit, which converts the DC input into three-phase AC outputs V_{A}, V_{B}, V_{C} that drive the motor 12. Each phase leg is configured with two inductors 18, 20 for phase A, two inductors 22, 24 for phase B, and two inductors 26, 28 for phase C, which are positioned to smooth out current flow and reduce ripples in the AC output. Similarly, phase A includes two capacitors 30, 31, phase B includes two capacitors 32, 33, and phase C includes two capacitors 34, 35. The capacitors are arranged with the inductors to create LC filter circuits to refine the AC waveform further, reducing harmonics and promoting smooth sinusoidal outputs.

Each phase leg also contains two active power switches (36, 38 for phase A; 40, 42 for phase B; and 44, 46 for phase C), which are typically silicon-carbide (SiC) MOSFETs. These high-speed switching devices enable rapid transitions for control of the AC waveform, allowing the inverter to operate at high frequencies and high voltages. The switches in each phase leg alternate to direct current through the inductors and capacitors, modulating the output voltage based on the desired motor control or charging conditions.

Switch 48 plays a role in determining the operation mode of the system 10. When the switch 48 is open, the system 10 operates in traction inverter mode, where the inverter outputs three-phase AC voltages to the motor 12. This AC output can be modulated to control the motor's speed and torque effectively. When the switch 48 is closed, the system 10 enters HVDC fast charging mode, connecting the HVDC fast charger station 16 to the inverter. In this mode, the inverter allows direct charging of the HV battery 14 without generating torque in the motor 12, effectively isolating the motor 12 from the charging circuit even though there is no physical disconnect switch between the motor 12 and inverter.

The phase-A voltage and the traction battery voltage have a relationship as follows:

$$\frac{{V}_{A}}{{V}_{d c}} = 2 - \frac{1}{D}$$

When the phase-A voltage is V_{A}=V_{D}+V sin ωt, the duty cycle to control the switch S2 is

$$D = \frac{1}{2 - ( {G}_{d c} + M sin ω t )}$$

$${G}_{d c} = \frac{{V}_{D}}{{V}_{d c}}$$

$$M = \frac{V}{{V}_{d c}}$$

$$M sin ω t \leq 1 - {G}_{d c}$$

In the traction inverter mode, the switch 48 is open. This mode allows the inverter to drive the electric motor 12, with the three-phase AC output voltages V_{A}, V_{B}, V_{C} feeding the motor 12. The system outputs an AC waveform with phase voltages that have an amplitude of MVdc when M≤1 and Gdc=0, resulting in zero common mode voltage (CMV) at the motor windings' neutral point. This inverter design outputs a voltage amplitude of MVdc, which is 1.73 times greater than that of a conventional inverter operating at the same modulation index (M<1). This increase in output voltage range allows the inverter to provide enhanced power to the motor 12 without incurring additional harmonics-related losses. When the modulation index is increased beyond 1 (M>1) and Gdc<1−M, the inverter further amplifies the voltage output, with the CMV becoming a constant instead of zero. For example, with M set to 1.2 and Gdc at −0.3, the phase voltage amplitude reaches 960V for an 800V battery, with a steady constant CMV of 240V. This provides more power while maintaining smooth sinusoidal outputs and does not prompt issues such as noise, vibration, and harshness, and electromagnetic interference.

In the HVDC fast charging mode, where switch 48 is closed, the DC fast charger station 16 is directly connected to the inverter. To facilitate HVDC fast charging, M is set to zero, and Gdc is configured to a negative value, effectively allowing each output phase V_{A}, V_{B}, V_{C} to provide a steady DC voltage suitable for charging the battery 14. For example, setting V_{A}, V_{B}, and V_{C} to 400V or 800V enables compatibility with 400V or 800V DC fast chargers, allowing the inverter to charge either 400V or 800V batteries without generating motor torque. Even without an additional switch between the motor and inverter, no current flows through the motor windings during charging such that the motor 12 remains inactive.

The inverter supports bidirectional power flow, enabling both buck and boost operations in a single stage. This modular arrangement allows each phase leg to operate independently, contributing to a scalable and adaptable design. Notably, the inverter system 10 achieves a higher voltage output range than conventional inverters, providing a potentially more efficient energy transfer while maintaining smooth sinusoidal waveforms, which reduces motor insulation requirements.

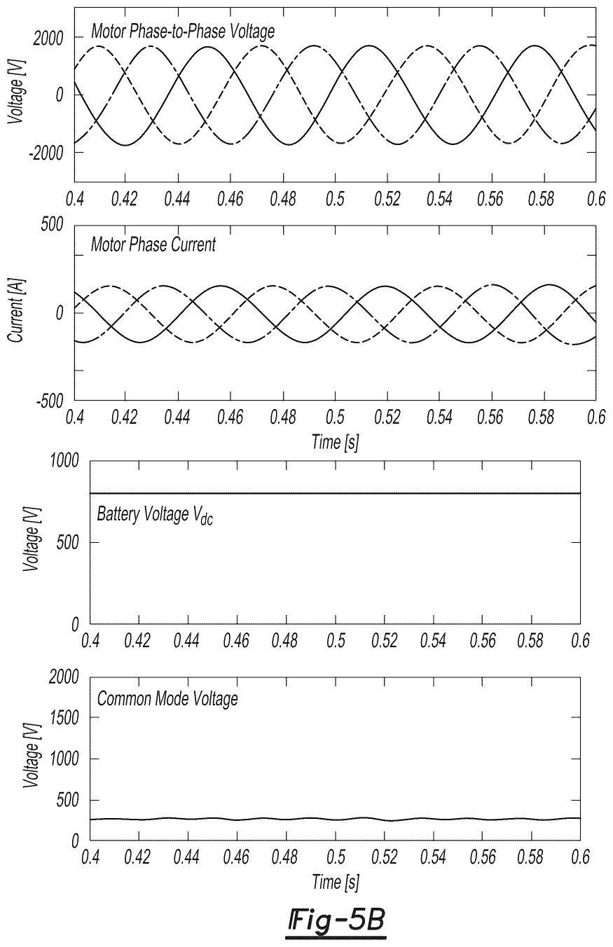

In FIG. 5A, the system operates with a battery voltage of 800V, modulation index M=0.8, and Gdc=0. Under these conditions, the motor phase voltage reaches a peak of 640V, while the phase-to-phase voltage amplitude is 1108V. The CMV at the motor windings' neutral point is zero, minimizing potential interference. In FIG. 5B, the modulation index is increased to M=1.2M with Gdc=−0.3, still operating at a battery voltage of 800V. This configuration results in a motor phase voltage peak of 960V, a phase-to-phase voltage amplitude of 1663V, and a steady CMV of 240V at the motor windings' neutral point.

By comparison, a traditional inverter controlled by space vector PWM would achieve a maximum phase voltage peak of only 462V and a maximum phase-to-phase voltage amplitude of 800V, with a PWM pulse CMV. The proposed inverter design, however, provides smooth sinusoidal waveforms for phase voltages, with the CMV being either zero or a constant value, as demonstrated in FIGS. 5A and 5B.

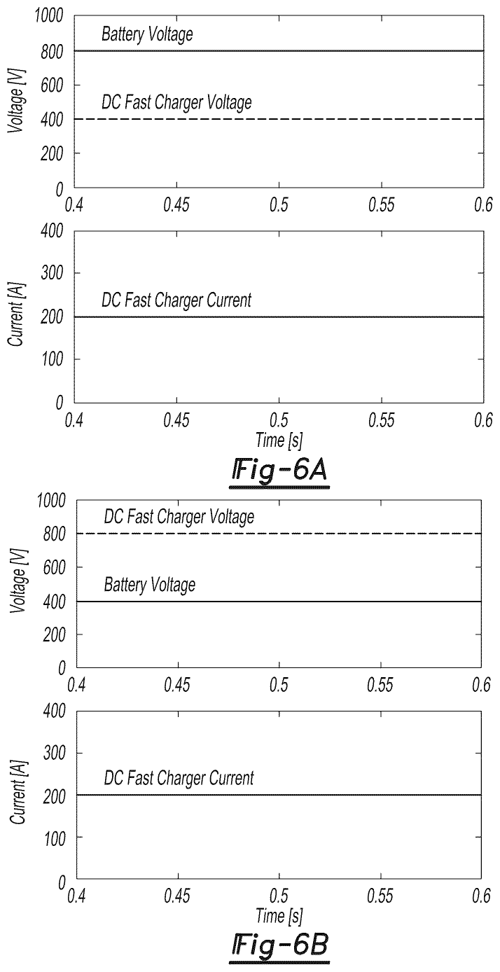

In FIG. 6A, a simulation demonstrates the charging of an 800V traction battery using a 400V DC fast charger station. Similarly, FIG. 6B shows a simulation of charging a 400V traction battery with an 800V DC fast charger station. This flexibility enables the electric vehicle to charge its traction battery at either 400V or 800V DC fast charger stations, regardless of whether the battery itself is 400V or 800V. In contrast, conventional systems, such as that shown in FIG. 3, lack this capability and cannot charge a 400V traction battery from an 800V DC fast charger station.

Although exemplary embodiments are described above, they are not intended to encompass all possible implementations of the design. The language used in this specification is descriptive rather than limiting, and it is understood that various modifications may be made without departing from the spirit and scope of the design. Furthermore, features from different embodiments may be combined to create additional implementations of the design.

What is claimed is:

1. A vehicle comprising:
a traction battery;
a motor;
an inverter arrangement, electrically connected between the traction battery and motor, including a plurality of phase legs each having a pair of switches and a first capacitor connected in series between the pair of switches, and a first plurality of inductors each configured to be selectively connected in parallel with one of the pair of switches and the corresponding first capacitor; and
a switch bank configured to selectively electrically connect a charging station, when present, to the phase legs between the inverter arrangement and motor.

2. The vehicle of claim 1, wherein the inverter arrangement further includes a second plurality of inductors each including, for each of the phase legs, a terminal electrically connected between the one of the pair of switches and the corresponding first capacitor.

3. The vehicle of claim 2, wherein the inverter arrangement further includes a second plurality of capacitors each connected between one of the second plurality of inductors and a negative rail of the inverter arrangement.

4. The vehicle of claim 1, wherein each of the first plurality of inductors includes a terminal electrically connected between the other of the pair of switches and the corresponding first capacitor.

5. The vehicle of claim 1, wherein the switch bank is configured to be open during a traction mode of the inverter arrangement.

6. The vehicle of claim 5, wherein a common mode voltage at a neutral point of windings of the motor has a zero or non-zero steady value during the traction mode of the inverter arrangement.

7. The vehicle of claim 1, wherein the switch bank is configured to be closed during a fast charging mode of the inverter arrangement.

8. The vehicle of claim 7, wherein the inverter arrangement is configured such that the motor does not generate torque during the fast charging mode.

9. The vehicle of claim 1, wherein the inverter arrangement is configured to selectively output sinusoidal phase voltage waveforms to the motor.

10. An automotive power system comprising:
an inverter, configured to be electrically connected between a traction battery and a motor, including a plurality of phase legs each having a pair of switches and a capacitor connected in series between the pair of switches, a first plurality of inductors each configured to be selectively connected in parallel with one of the pair of switches and the corresponding capacitor, and a second plurality of inductors each including a terminal electrically connected between the one of the pair of switches and the corresponding capacitor.

11. The automotive power system of claim 10, wherein each of the first plurality of inductors includes a terminal electrically connected between the other of the pair of switches and the corresponding capacitor.

12. A vehicle comprising:
an electric drive system including a traction battery, a motor, and an inverter arrangement, electrically connected between the traction battery and motor, wherein the inverter arrangement includes a plurality of phase legs each having a pair of switches and a capacitor connected in series between the pair of switches and an inductor including a terminal electrically connected between the one of the pair and the corresponding capacitor.

13. The vehicle of claim 12, wherein the inverter arrangement further includes a second plurality of inductors each including, for each of the phase legs, a terminal electrically connected between the one of the pair of switches and the corresponding capacitor.

14. The vehicle of claim 12 further comprising a switch bank configured to selectively electrically connect a charging station, when present, to the phase legs between the inverter arrangement and motor.

15. The vehicle of claim 14, wherein the switch bank is configured to be open during a traction mode of the inverter arrangement.

16. The vehicle of claim 15, wherein a common mode voltage at a neutral point of windings of the motor has a zero or non-zero steady value during the traction mode of the inverter arrangement.

17. The vehicle of claim 14, wherein the switch bank is configured to be closed during a fast charging mode of the inverter arrangement.

18. The vehicle of claim 15, wherein the inverter arrangement is configured such that the motor does not generate torque during the fast charging mode.
